(19) United States
(12) Patent Application Publication
(10) Pub. No.: US 2013/0198016 A1
(43) Pub. Date: Aug. 1, 2013

(54) METHOD AND SYSTEM FOR CROSS-AUTHORIZATION FOR ONLINE TRANSACTIONS

(71) Applicant: Suren Ter-Saakov, Trevose, PA (US)

(72) Inventor: Suren Ter-Saakov, Trevose, PA (US)

(21) Appl. No.: 13/744,353

(22) Filed: Jan. 17, 2013

Related U.S. Application Data
(60) Provisional application No. 61/587,639, filed on Jan. 17, 2012.

(51) Int. Cl. G06Q 30/02

(52) U.S. Cl. CPC G06Q 30/0277
USPC 705/14.73

(57) ABSTRACT

Embodiments described herein disclose a first processor configured to receive data associated with a user, the data corresponding to at least one action performed by the user associated with a first webpage and an identification of the user. The first processor being further configured to determine if the user has browsed to a second webpage before completing the at least one action associated with the first webpage. The system may further include a second processor configured to communicate data to be displayed on an advertisement on the second webpage, the data being associated with the at least one action associated with the first webpage and the identification of the user. Furthermore, the system may include an interface configured to receive data via the advertisement to complete the at least one action associated with the first website.

### PRIORITY CLAIM

This application claims priority to U.S. provisional patent application Ser. No. 61/587,639, titled “CROSS-AUTHORIZATION METHOD FOR INCREASING COVNERSION RATES ACROSS WEBSITES AND PLATFORMS” filed on Jan. 17, 2012, which is hereby incorporated herein in its entirety.

### BACKGROUND

1. Field

This disclosure relates to methods and systems pertaining to online transactions, online forms and web-browsing. More specifically, this disclosure describes methods and systems relating to e-commerce, online shipping and marketing.

2. Description of Related Art

Conventionally, if a consumer desires to purchase a good and/or service from a website, the consumer may view the desired goods and/or services on the online merchant's website. Then, the consumer may select the desired product on the merchant's website, the desired product may be placed in a shopping cart associated with the consumer, and then a check-out process may be initiated to purchase the selected product(s). However, if the consumer navigates away from the merchant's website to another website before completing the check-out process, the merchant may lose a sale to the consumer.

To increase conversion rates across websites, websites may include banners or advertisements that are related to a search history associated with a user. The banners or advertisements may include ads or promotions corresponding to products that a consumer may have recently searched for on a search engine or products viewed on an online merchant's website. For example, the banner may include an advertisement for the product that the consumer initiated a check-out process for but did not complete.

However, upon clicking or selecting the banner to return to the website, the consumer may need to login to the merchant's website, once again select the desired products, view the shopping cart with the desired products, and complete the check-out process for the order that was abandoned. Accordingly, if a user abandons a check-out process to view another website, the user must begin that process all over again to later complete the transactions.

Needs exist for improved systems and methods for completing abandoned online transactions.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. In certain embodiments, the disclosed embodiments may include one or more of the features described herein.

Example embodiments disclosed herein describe devices, methods, systems, and apparatuses that are configured for increasing conversion rates for goods and/or services across websites and platforms by targeting users who may have abandoned an online transaction on a vendor's website prior to completion. More specifically, users or consumers who have started an online transaction on a vendor's website without completing the transaction may be identified, targeted and/or located if the user has navigated to other online sites. The users may then be targeted with a banner ad, link or connection that allows the user to complete the abandoned transaction directly from the other online websites. Therefore, conversion rates for goods and/or services may be increased by allowing users to complete a previously abandoned transaction directly from other websites if the consumer has navigated away from an online vendor website.

Accordingly, by eliminating the required or necessary steps for a user to return to a vendor's website to complete an online transaction, a vendor may increase their conversion rate and overall sales. Furthermore, vendors that allow users to login and register with their websites may be able to complete their abandoned transactions via “one-click checkouts” whenever and wherever desired.

Embodiments described herein disclose a computing device configured to receive data associated with a user, the data corresponding to at least one action performed by the user and associated with a first webpage and an identification of the user. The first processor is further configured to determine if the user has browsed to a second webpage before completing the at least one action associated with the first webpage. The system may further include a second processor configured to communicate data to be displayed on an advertisement on the second webpage, the data being associated with the at least one action associated with the first webpage and the identification of the user. Furthermore, the system may include an interface configured to receive data via the advertisement to complete the at least one action associated with the first website.

### BRIEF DESCRIPTION OF THE DRAWINGS

The features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIGS. 1-4 depict embodiments of remarketing products according to the conventional art.

FIG. 5 depicts a block diagram illustrating an exemplary computing environment in accordance with an embodiment.

FIG. 6 depicts an embodiment of computing environment according to an embodiment.

FIG. 7 depicts a network flow diagram illustrating interactions between network devices according to an embodiment.

FIG. 8 depicts a network flow diagram allowing a customer to complete a transaction on a second client device that was abandoned by a first client device according to an embodiment.

FIG. 9 depicts an example embodiment of a flow diagram utilizing a cross-authorization method for increasing conversion rates across websites and platforms according to an embodiment.

FIG. 10 depicts an example embodiment of a flow diagram utilizing a cross-authorization method for increasing conversion rates across websites and different devices according to an embodiment.

FIGS. 11-14 depict graphical user interfaces that may be displayed on a screen of a user device to complete a transaction according to an embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will be described herein in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. The existence of any given numbered element does not imply the existence of any other numbered element in the same embodiment, for example a third element does not imply the existence of a second element in a given embodiment. The term “third element” may simply be used to distinguish from a first element or second element in a different embodiment. As used herein, the terms “or” and “and/or” include any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

One skilled in the art will realize that the term merchant may refer to any store, vender, supplier of goods and/or services, manufacturer, and the like either at a physical store or via an online storefront. Furthermore, the term product may refer to tangible goods, intangible goods, services and/or any form of transferable commodity.

Currently, between one third and three quarters (averaging two thirds) of users who have started an online transaction by placing items in an online shopping cart abandon their online transaction. In other words, if an online merchant completes ten sale orders in a day, about twenty customers that placed items in their online shopping cart for the online merchant will not complete their transactions.

Merchants may advertise, promote, and/or encourage consumers to purchase products both at a physical store and/or via an online storefront associated with the physical store. While a prospective customer is navigating an online storefront, the prospective customer may place items within an online cart, be informed of the items within their cart, and be encouraged to complete a transaction to purchase the items within their cart via the online storefront.

However, if the potential customer navigates away from the online storefront to another website prior to completing a transaction, the transaction may be abandoned, lost or forgotten. Thus, the online merchant may not receive profits associated with the sale of goods corresponding to the abandoned transaction.

Currently, by utilizing advertisements in the form of links and/or banners, online merchants may try to increase sales or conversion rates of products associated with transactions that are abandoned. More specifically, online advertisement companies may track, store and/or identify a search history associated with a potential customer and display relevant advertisements via a banner ad within another website corresponding to the potential customer. Consequently, if a potential customer abandons a transaction at an online merchant's website by navigating to another website, an advertisement associated with the previously abandoned transaction may be placed within a banner ad on another website. Yet, to complete the previously abandoned transaction, the potential customer may be required to click on the banner, return to the online merchant's website, reselect the desired product(s), and re-enter user information to complete the abandoned transaction.

Embodiments as described below allow a potential customer to complete a previously abandoned transaction via a banner, advertisement, or link on another website. Furthermore, embodiments as discussed below allow a potential customer to complete a previously abandoned transaction on a different device than was used to initialize the abandoned transaction.

Although embodiments described below relate to completing a previously abandoned transaction relating to purchasing goods and/or services directly via a banner on another website, one skilled in the art will realize that the abandoned transaction may not be for goods and/or services and may be for any type of transaction, such as registering for a website, filling out forms, or any other transaction that may require a user interaction.

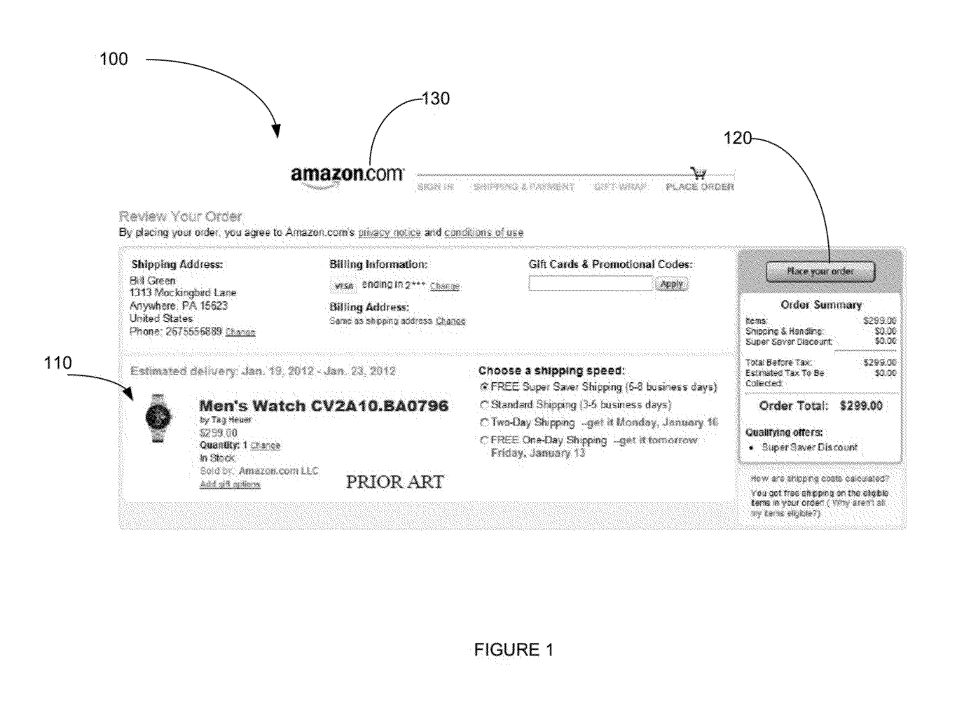

FIGS. 1-4 depict embodiments of remarketing products according to conventional art. FIG. 1 depicts a checkout screen 100 reached by a customer after selecting a product 110 from an online storefront 130.

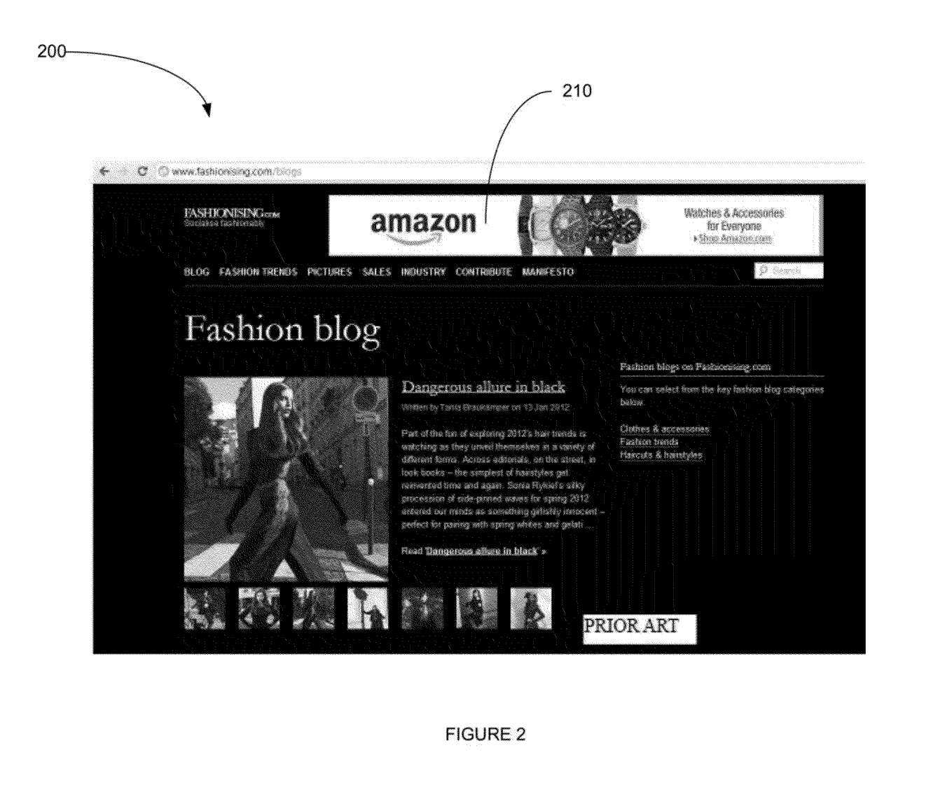

However, the customer may navigate away from checkout screen 100, without clicking the “place your order” button 120 to complete the transaction, to another website 200 as depicted in FIG. 2. The other website 200 may include ad banner 210 that is associated with product 110 for online storefront 130.

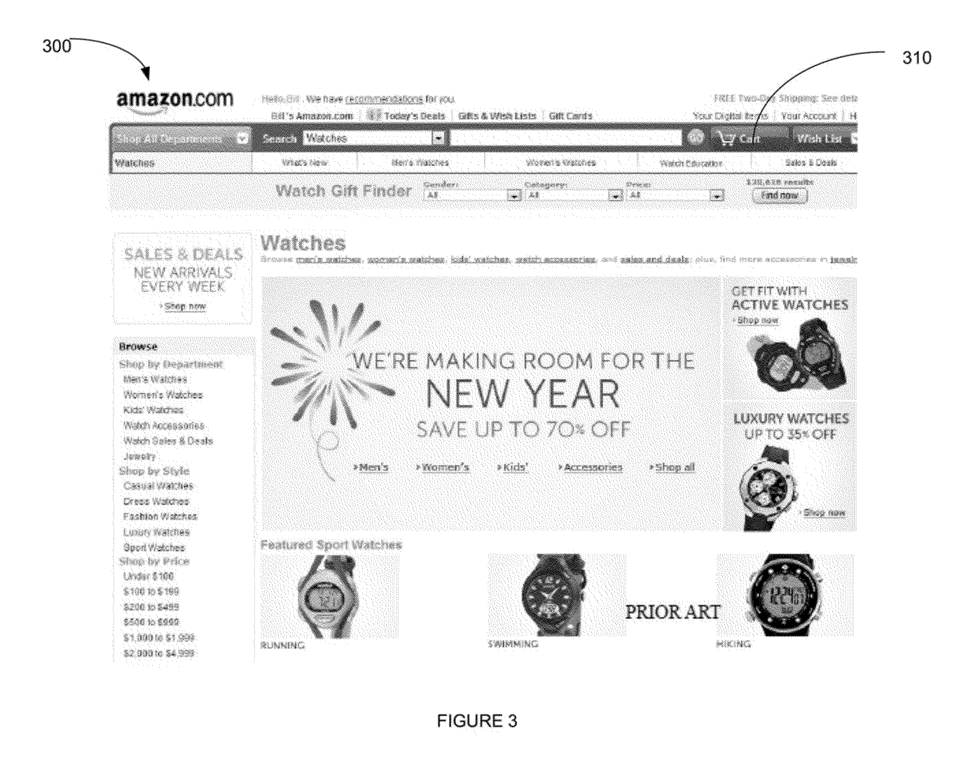

If a customer clicks ad banner 210, the customer may be linked to a home page 300, as shown in FIG. 3, for online store front 130. The customer may then need to select a shopping cart button 310 to link the customer to a checkout screen as depicted in FIG. 1.

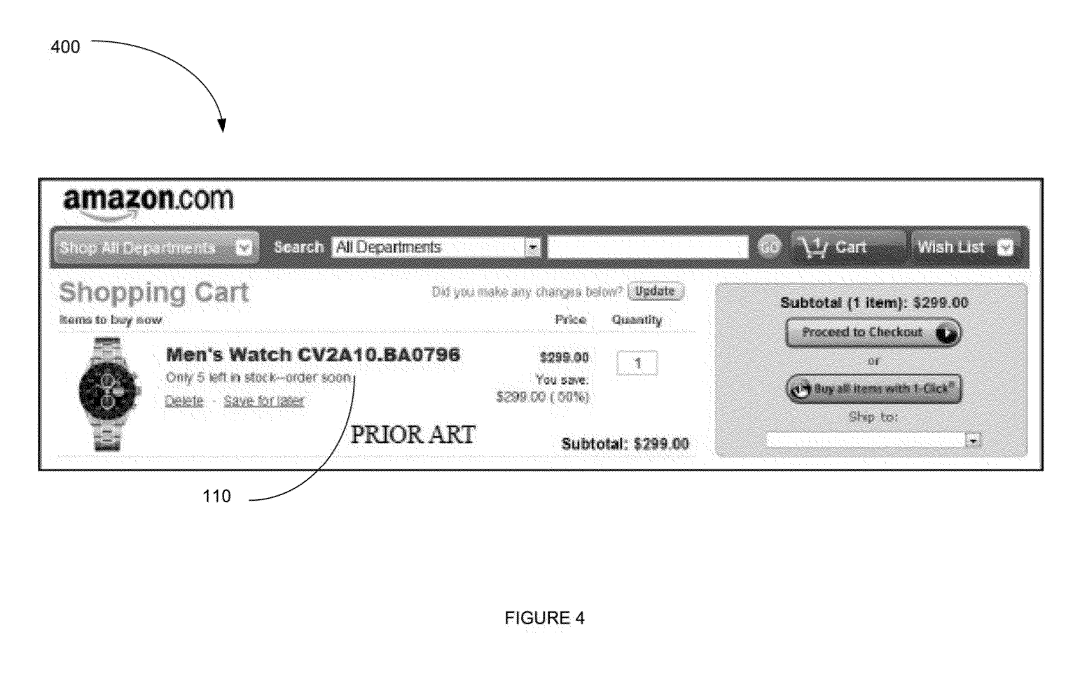

Upon selecting shopping cart button 310 the customer may be linked to a shopping cart web page 400, as shown in FIG. 4, to complete the transaction associated with checkout screen 100 and product 110 that was abandoned earlier. Upon a customer completing the transaction associated with shopping cart webpage 400, the customer may be linked to a transaction completion webpage that may include a confirmation of the transaction. Accordingly, if a user abandons a check-out process to view another website, a plurality of steps are required to complete the previously abandoned transaction.

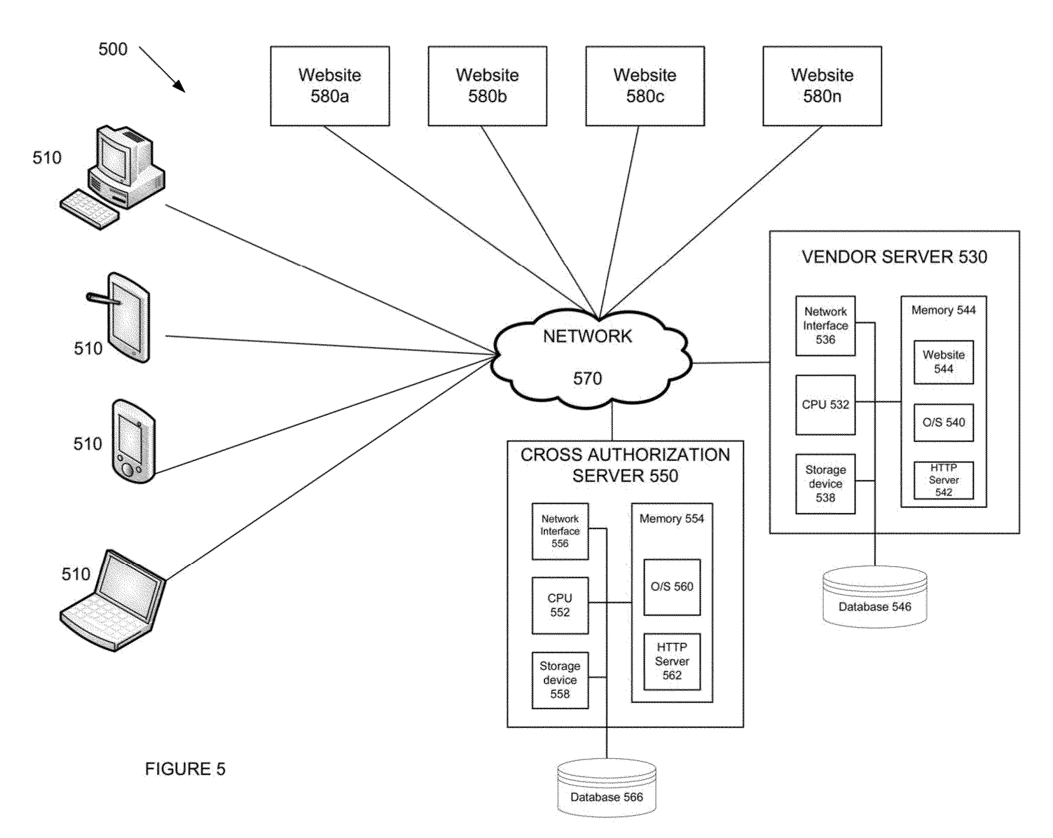

Turning now to FIG. 5, FIG. 5 depicts a block diagram illustrating an exemplary computing environment 500 in accordance with an embodiment. Computing environment 500 may include client devices 510, vendor server 530, cross-authorization server 550, network 570 and/or websites 580a-n.

Specifically, client devices 510 are communicatively coupled to vendor server 530, websites 580 and a cross-authorization server 550 via network 570. More so, vendor's server 530 and cross-authorization server 550 may also be communicatively coupled to each other via network 570.

Network 570 may be any wireless or wired communication network such as the Internet or wide area network (WAN), publicly switched telephone network (PTSN) or any other type of electronic link configured to communicate data between devices.

Websites 580 may be any websites capable of being browsed by a client device 510 utilizing a web browser. For example, website 580a may be a news site, 580b may be a sports site, and website 580c may be a blogger's web page.

Client devices 510 may be any computer system, personal data assistant, kiosk, mobile telephone, smart phone, wireless computer, wired computer, etc. with processors configured to communicate data over network 570. For example, client devices 510 may utilize a web browser to navigate the internet, complete online transactions and/or fill out forms over network 570.

Vendor server 530 may be utilized to provide support to any website on the internet. For example, vendor server 530 may be associated with a retail outlet with an online store front configured to sell goods and/or services, or any website requiring a user to fill out forms or provide data over network 570. More specifically, vendor server 530 may be associated with Amazon.com® or any other retailer that sells a plurality of goods for various companies. In another embodiment, vendor server 530 may be associated with Nike.com® that may only sell Nike®-brand products. In further example embodiments, there may be a plurality of vendor servers 530.

Furthermore, vendor server 530 may be a server computer including a CPU 532, a memory 534, a network interface device 536, and/or a storage device 538 coupled via a bus. HTML documents and media such as text, image, video, audio, and/or advertisements for a website 544 may be stored in the storage device 538.

Memory 534 may be, in accordance with one or more embodiments, a random access memory sufficiently large to hold necessary or desired programming and data structures that are located on vendor server 530. As shown, memory 534 may store an operating system (O/S) 540 used to manage server hardware and/or software executing on vendor server 530. For example, memory 534 may include information regarding products and prices for products sold by an online storefront associated with vendor server 530, or data corresponding to registered users. Illustratively, memory 534 may also include a hypertext transfer protocol (http) server 542 that may be configured to service requests from client devices 510 and other networked devices, such as cross-authorization server 550. For example, the http server 542 may respond to requests for access to electronic resources for website 544 (e.g., HTML documents, network information, data to be displayed on a graphical user interface at a client device 510, and/or the like) residing on the vendor server 530. However, one of ordinary skill in the art will recognize that the http server 542 is merely illustrative and embodiments of the invention may be adapted to support both known and unknown protocols. The programming and data structures of the http server 542 may be accessed and executed by the CPU 532 as needed during operation.

Vendor server 530 may connect to networked devices over network 570 using the network interface device 536 (e.g., an analog modem, a wired network card, a wireless network device, and/or the like).

In one embodiment, vendor server 530 may include a database 546 that may be configured to store information or data associated with users who access website 544. For example, an entry of database 546 may include information regarding a user account, browser activity on the website 544, preferences for a user, user information such as a login name, password, user identification number, address, payment methods, etc. associated with various users who purchase goods at an online store front for website 544, items within a shopping cart associated with a user for website 544, search history for a user, and the like. These items may be stored in database 546 via any known form of storing items in a database such as look-up-tables, name value pairs, cookies, etc.

Cross authorization sever 550 may be a server configured to track, record and store data associated with client devices 510 or specific users browsing the internet. For example, cross authorization server 550 may track, record, and store data associated with a client device 510 or a specific user browsing website 544. Further, cross authorization server 550 may be a server computer including a CPU 552, a memory 554, a network interface 556 and/or a storage device 558 coupled via a bus.

Memory 554 may be, in accordance with one or more embodiments, a random access memory sufficiently large to hold necessary or desired programming and data structures that are located on cross-authorization server 550. As shown, memory 554 may store an operating system (O/S) 560 used to manage server hardware and/or software executing on cross authorization server 550. For example, memory 554 may include information regarding products and prices for products viewed, purchased or placed in an online shopping cart associated with website 544 by a user utilizing client device 510. Illustratively, memory 554 may also include a hypertext transfer protocol (http) server 562 that may be configured to service requests from client devices 510 and other networked devices, such as vendor server 530. For example, the http server 562 may respond to requests for access to browsing data associated with a client device 510 or user (e.g., HTML documents, network information, data to be displayed on a graphical user interface at a client device 510, and/or the like). However, one of ordinary skill in the art will recognize that the http server 562 is merely illustrative and embodiments of the invention may be adapted to support both known and unknown protocols. The programming and data structures of the http server 562 may be accessed and executed by the CPU 552 as needed during operation.

Cross authorization server 550 may connect to other networked devices over network 570 using the network interface device 556 (e.g., an analog modem, a wired network card, a wireless network device, and/or the like). In one embodiment, cross-authorization server 550 may include a database 566 that may be configured to store information or data associated with users who access website 544. For example, an entry of database 566 may include information regarding a user account, browser activity on the website 544, preferences for a user, user information such as a login name, password, user identification number, address, payment methods, etc. associated with various users who purchase goods at an online store front for the website 544, items within a shopping cart associated with a user for website 544, search history for a user, and the like. These items may be stored in database 566 via any known form of storing items in a database such as look-up-tables, name value pairs, cookies, etc.

Utilizing a client device 510, vendor server 530 and cross authorization server 550, cross authorization server may be utilized to display a banner ad with an abandoned transaction associated with website 544 on another website 580. Thus, a user utilizing client device 510 may complete a transaction for website 544 directly on the banner ad on website 580 without having to navigate to website 544.

More specifically, in an embodiment vendor server 530 may record, capture and/or store a customer's activity on website 544 in database 546. Then, vendor server 530 may communicate data associated with the customer's activity on website 544 to cross authorization server 550, and cross authorization server 550 may store this data on database 566. Thus, the customer's activity is captured by the cross authorization server 550 via database-level integration with the vendor server 530. Alternatively, the vendor server 530 may leverage a custom-tailored Java script powered by the cross authorization server 550 that captures all of a customer's activity in the vendor's forms and transmits it both to the cross authorization server database 566 and to the vendor server database 546. Thus, in this embodiment the customer's activity is captured by cross authorization server 550 via front-end level integration with the vendor server 530 (the vendor's front-end utilizes the cross authorization front-end Java script).

Furthermore, website 544 may include a pixel to track or mark a consumer associated with client device 510. This tracking pixel may be any object stored on the cross authorization server 550, such that when the website 544 is requested by a client device 510, a request for the tracking pixel is sent to the cross authorization server 550, and cross authorization server 550 becomes aware of the incoming request and can note the IP address and other relevant information relating to the request and also install a cookie or other object (such as a Local Shared Object) on the requesting client device 510.

The pixel may be used to track the consumer associated with client device 510 across a plurality of websites 580. For example, websites 580 may also include a pixel from cross authorization server 550. This pixel may for example be a part of an ad on the page. When client device 510 requests a page from website 580 via an http request, the pixel associated with cross authorization server 550 is also requested from server 550, which allows the cross-authorization server 550 to recognize or identify the customer associated with client device 510 using a previously-installed cookie.

Although the tracking “pixel” may in some embodiments be an e.g. 1×1.gif image stored on the cross authorization server 550, in other embodiments it may instead be JavaScript, a Flash object or Silverlight stored on the cross-authorization server 550. Thus, a browser on a client device 510 may execute flash code, and cross-authorization server 550 may utilize a previously installed Local Shared Object to track a client device 510 or user across various websites 580. Or, the browser may execute Javascript, and cookies can be utilized by the cross authorization server 550 to track a client device 510 or user.

Website 580 may request a banner ad to be displayed from cross authorization server 550. For example, website 580 may transmit an http request with a cookie identifying a client device 510. Cross authorization server 550 may then search an associated database 566 to identify if the cookie identifying client device 510 has a corresponding entry. If there is a corresponding entry within the database 566, cross-authorization server 550 may retrieve the last entry associated with client device 510 or an entry within the database 566 associated with client device 510 and an abandoned transaction. Cross-authorization server 550 may then form data for a graphical representation associated with a banner ad. The data for the graphical representation for the banner ad may then be communicated from cross-authorization server 550 to website 580. Website 580 may transmit data for the banner ad to be displayed on a display of client device 510. The user associated with client device 510 may fill out missing forms or items within the banner ad and/or complete the previously abandoned transaction for website 544 on the banner ad within website 580. The banner ad may be formed dynamically in any known fashion, for example using html, flash, Silverlight, and/or an image file.

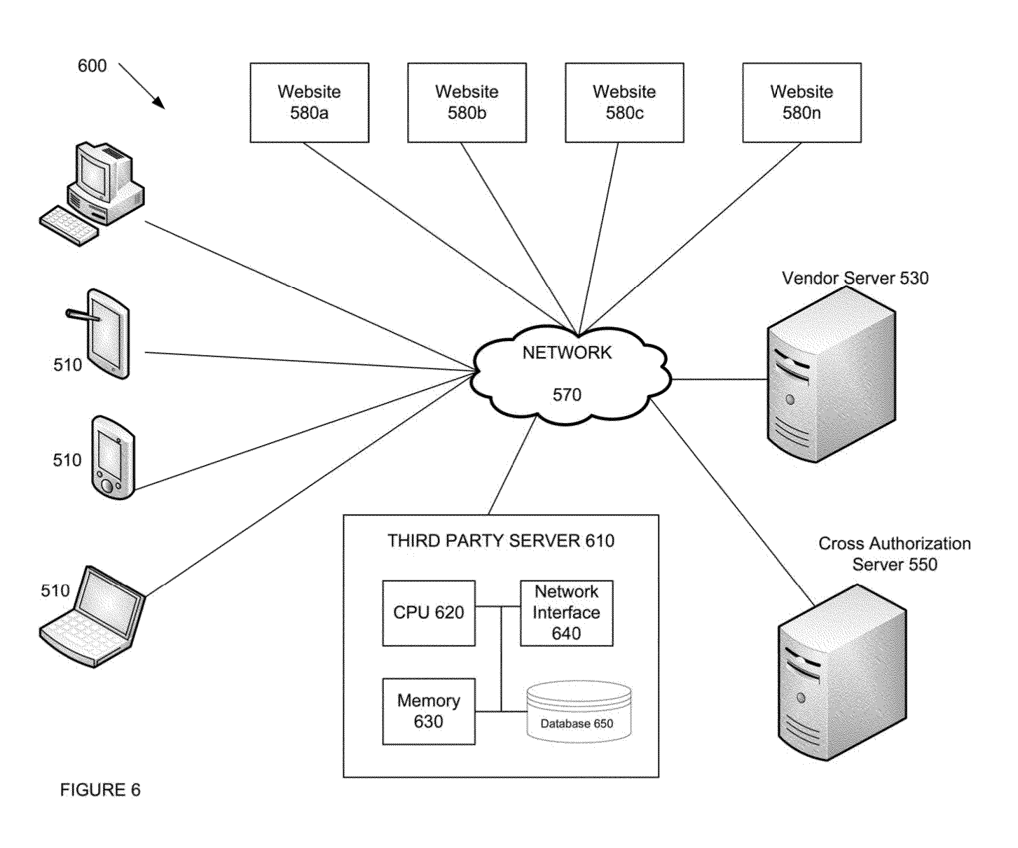

FIG. 6 depicts an embodiment of computing environment 600, computing environment 600 may be similar to the computing environment 500 as depicted in FIG. 5 but may include a third party server 610.

Third party server 610 may be a server that is configured to track, record, and/or store data associated with a user utilizing a client device 510 to browse websites over network 570. For example, third party server may be a Google® or Microsoft® server configured to track interactions of a user over a number of websites over network 570.

Furthermore, third party server 610 may include a CPU 620, memory 630, network interface 640 and/or database 650.

Memory 630 may be, in accordance with one or more embodiments, a random access memory sufficiently large to hold necessary or desired programming and data structures that are located on third party server 610.

Network interface 640 may be configured to connect third party server 610 to other networked devices over network 570.

Database 650 may be configured to store information or data associated with users who access websites. For example, an entry of database 650 may include information regarding a user account, browser activity on various websites over network 570, preferences for a user, user information such as a login name, password, user identification number, address, payment methods, etc. associated with various users who purchase goods over network 570 a search history for a user over various websites, and the like. These items may be stored in database 650 via any known form of storing items in a database such as look-up-tables, name value pairs, cookies, etc.

One skilled in the art will understand that although servers 530, 550 and 610 are depicted as separate network elements/devices, in other embodiments the servers may be depicted in other forms. For example, in an embodiment cross-authorization server 550 may be a module within vendor server 530 or within third party server 610. As such, cross-authorization server 550 may be a processor that may be disposed within any networked device.

Utilizing third party server 610, a banner ad may be displayed on a website 580 if a user associated with client device 510 has abandoned a transaction associated with vendor server 530. More specifically, the banner ad displayed on website 580 may be associated with the abandoned transaction associated with vendor server 530. Thus, a user utilizing client device 510 may complete a transaction directly on the banner ad on website 580 for vendor server 530 without having to navigate and/or reconnect to vendor server 530.

In an embodiment, vendor server 530 may include a pixel associated with cross-authorization server 550 that also contains a pixel associated with third party server 610. Accordingly, if a customer associated with client device 510 visits or browses website 544, he may get cookied (or e.g. have an LSO installed) by the third party server 610. Accordingly, third party server 610 may track, recognize or identify the customer associated with client device 510 across the internet. For example, if the customer associated with client device 510 views another website 580, such as website 580a, the third party server 610 may track the customer associated with client device 510. For example, the website 580 may include a pixel associated with cross authorization server 550 (for example within an ad), which contains or calls a pixel associated with the third party server 610. Thus, when a page from website 580 containing the pixel is requested, the cross authorization pixel and thus the third party pixel is also requested, allowing the third party server 610 to recognize/identify the requester associated with client device 510 using a previously installed cookie, LSO, etc. The third party's identification of the requestor will not be apparent to the cross authorization server 550 until later in the process when the third party server 610 requests the appropriate banner for the identified requestor.

If the customer associated with client device 510 requests a page from website 580, the page may include a banner tag (which is a type of pixel) from the third party server 610. The banner tag may recognize the customer using the process described above utilizing the banner tag, network identification associated with the customer, and the database 650. If there is not a corresponding entry within database 650 associated with the network identification for the customer and the banner tag, then third party system 610 may not communicate a request to cross-authorization server 550, or third party system 610 may send an message identification that there was no entry within the database 650 associated with the network identification for the customer and the banner tag.

However, if the customer is recognized by the third party sever 610 as having a corresponding entry within database 650, then third party server 610 may communicate a call to cross authorization server 550. The call may include a unique network identification originally exchanged between the cross authorization server 550 and the third party server 610 at the time of entering the user's information into cross authorization database 550. Accordingly, cross-authorization server 550 may recognize which customer in database 566 is associated with the call from third party server 610. Cross-authorization server 550 may then form data corresponding to a graphical representation for a banner ad and communicate it to third party server 610. Third party system 610 may then communicate the data corresponding to the graphical representation for the banner ad to website 580.

Website 580 may transmit data for the banner ad to be displayed on client device 510. The user associated with client device 510 may fill out missing forms or items within the banner ad and/or complete a previously abandoned transaction for website 544 directly on the banner ad within website 580 without having to navigate or reconnect to vendor server 530.

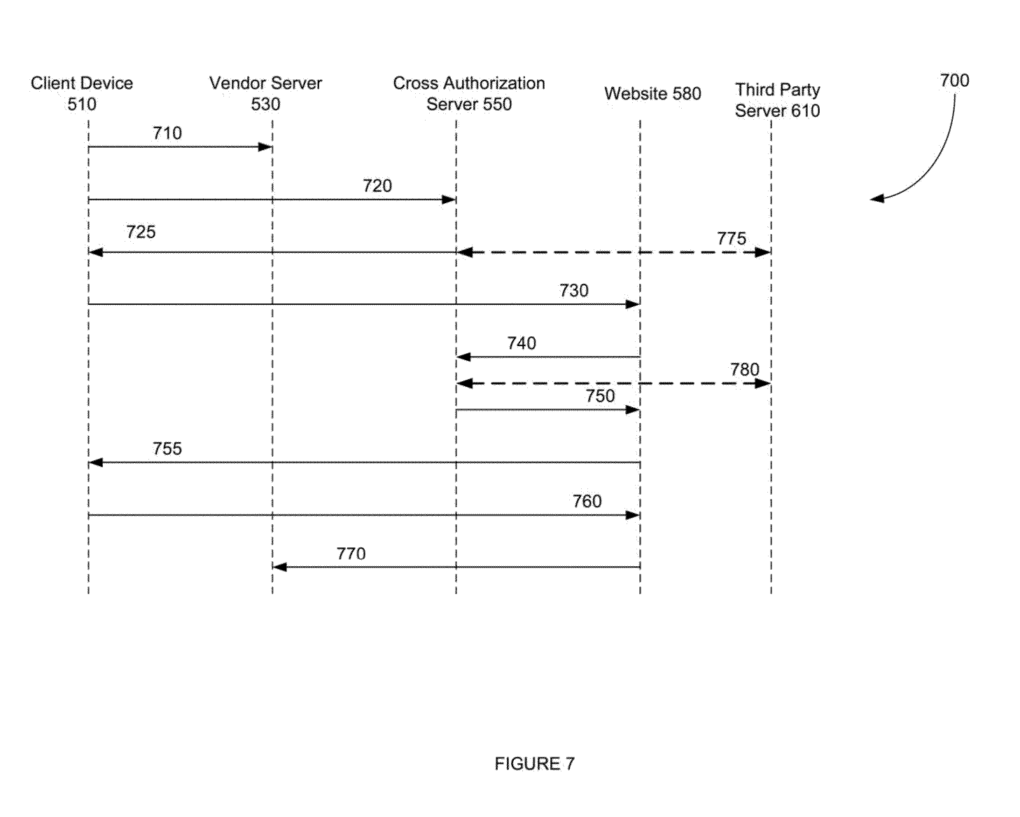

FIG. 7 depicts a network flow diagram 700 illustrating interactions between network devices within computing environment 500.

In 710, a user associated with client device 510 may request to view a page of website 544, containing a pixel associated with cross authorization server 550, on vendor server 530. Subsequently, client device 510 may browse website 544.

In 720, based on client device 510 requesting to view a page of website 544 containing a pixel associated with cross authorization server 550, a request may be sent to cross authorization server 550 to retrieve the pixel.

In 725, based on the request from client device 510 to retrieve the pixel (e.g. Java script), cross-authorization server 550 may transmit a cookie to client device 510. The cookie may include a unique cookie ID for client device 510. Simultaneously with transmitting the cookie to client device 510, cross authorization server 550 may create a record in database 566 of cross authorization server 550. The record in database 566 may track and record the activities of the client device 510 on website 544. For example, if a user associated with client device 510 began a multi-page checkout process with forms to be completed by the user, cross-authorization server 550 may update database 566 based on the cookie ID and the user's form entries. Records may continually be added to the database against the cookie ID as forms are completed.

In 730, the user associated with client device 510 may request to view website 580 without completing the multi-page checkout process. Further, website 580 may include a banner ad to be displayed on a graphical user interface on client device 510.

In 740, website 580 may communicate an http request to cross-authorization server 550 that the user associated with client device 510 has requested to view website 580 containing a banner stored on the cross authorization server 550. Based on a cookie ID within the http request, cross-communication server 550 may determine if the user associated with client device 510 has any records within database 566.

In 750, when the cookie ID within the http request does match identification within database 566, cross authorization server 550 may transmit data to be placed within a banner ad on website 580 to website 580. Furthermore, the banner ad may include information corresponding with the checkout process abandoned by the user associated with client device 510. For example, the banner ad may include forms to be completed by the user associated with client device 510 such as a shipping address and method of payment and/or an image of the object to be purchased. If the cookie ID does not match, the banner ad data may be generic, irrelevant, or use banner data from another source.

In 755, website 580 may transmit a webpage with the banner ad to be displayed on client device 510. In 760, the user associated with client device 510 may transmit data to be entered on the banner ad within website 580, and complete the transaction associated with vendor server 530 on website 580.

In 770, website 580 may communicate data associated with the completed transaction to vendor server 530. Accordingly, the user associated with client device 510 does not have to navigate to vendor server 530 or transmit any data directly to vendor server 530 to complete the previously abandoned transaction.

In a further example embodiment, utilizing third party server 610, third party server 610 may exchange a unique network identification with cross authorization server 550 at step 775. Third party server 610 and cross authorization server 550 may again exchange the unique network identification at 780. In this embodiment, the third party server 610 installs the cookie ID on the client device 510 at 725 and receives the cookie ID at 780 to identify the user before exchanging the appropriate unique network ID with the cross authorization server 550 to retrieve the banner ad data.

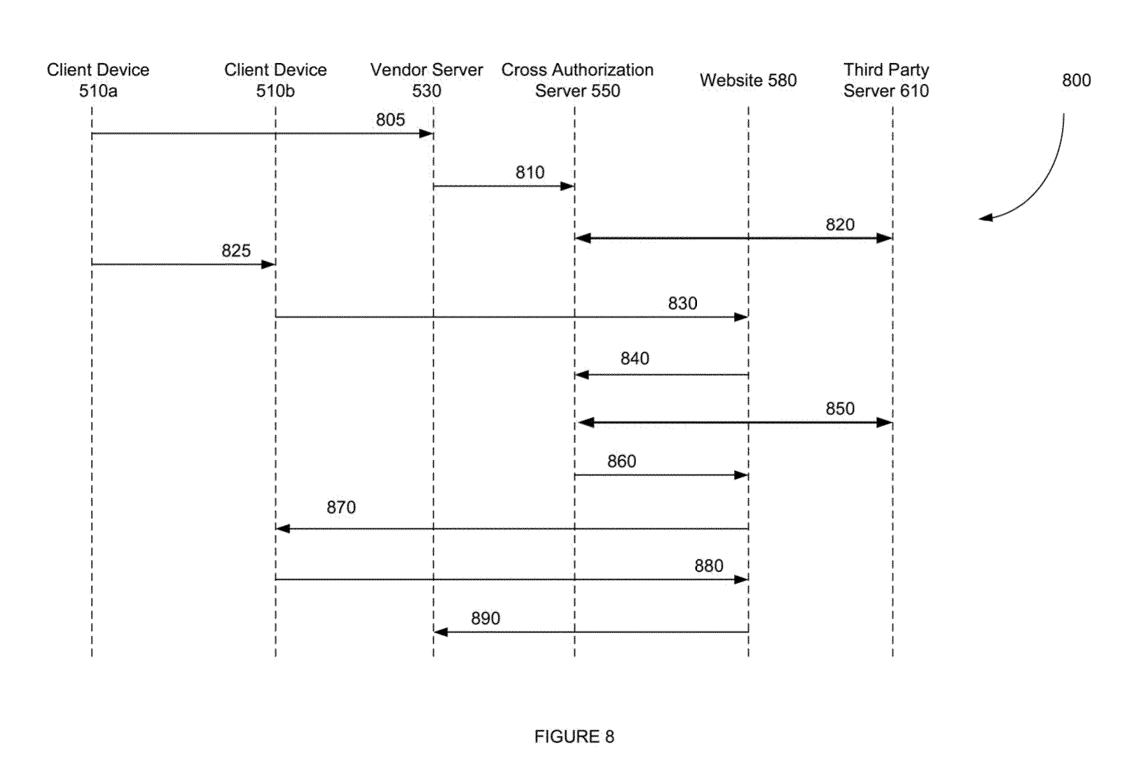

FIG. 8 depicts a network flow diagram allowing a customer to complete on a second client device 510b transactions previously abandoned on a first client device 510a, utilizing a third party server 610 according to an embodiment. Furthermore, in a network topology associated with FIG. 8, third party server 610 may include a module to access and/or process the functionality of cross authorization server 550. For example, third party server 610 may be associated with a Facebook®, Twitter®, and/or Google® account. Alternatively, third party server 610 may be associated with a browser such as Chrome® or other software that supports sharing cookies between different machines associated with a user. In this embodiment, the only purpose of the third party server (which may be a second third party server, used in conjunction with a third party server as described previously) is to share the cookie ID across different client devices. In this way, the cookie ID, once transmitted, may be shared across all client devices and trigger the cross authorization server regardless of the device used. Otherwise, the process may be as described above.

In 805, a user associated with a first client device 510a may request to view a page of website 544, containing a pixel associated with cross authorization server 550, on vendor server 530. Subsequently, client device 510a may browse the website.

In 810, based on the first client device 510a requesting to view a page of the website containing a pixel associated with cross authorization server 550, a request may be sent to cross authorization server 550 to retrieve the pixel. Also, cross authorization server 550 may create a record in database 566 in cross authorization server 550. The record in database 566 may track and record the activities of the client device 510a on the website. For example, if a user associated with client device 510a began a multi-page checkout process with forms to be completed by the user, cross-authorization server 550 may update database 566 based on a cookie ID for the user and the user's form entries. Records may continually be added to the database against the cookie ID as forms are completed.

In 820, third party server 610 may exchange a unique network identification with cross authorization server 550. The unique network identification may be used to track a user across a plurality of client devices.

In 825, the user using client device 510a may begin using client device 510b, and in 830 begin browsing website 580, which may be any website on the internet, before completing the checkout process.

In 830, the user using client device 510b may request to view website 580. Further, website 580 may include a banner ad to be displayed on a graphical user interface on client device 510.

In 840, website 580 may communicate an http request to cross-authorization server 550 that the user associated with client device 510b has requested to view website 580 containing a banner stored on the cross authorization server 550.

In 850, third party server 610 and cross authorization server 550 may again exchange the unique network identification based on a cookie ID within the http request received in 840. Further, using the network identification cross-authentication server 550 may determine if the user associated with client device 510b has any records within database 566.

In 860, when the cookie ID within the http request does match identification within database 566, cross authorization server 550 may transmit data to be placed within a banner ad on website 580 to website 580. Furthermore, the banner ad may include information corresponding with the checkout process abandoned by the user associated with client device 510a. For example, the banner ad may include forms to be completed by the user associated with client device 510b such as a shipping address and method of payment and/or an image of the object to be purchased. If the cookie ID does not match, the banner ad data may be generic, irrelevant, or use banner data from another source.

In 870, website 580 may transmit a webpage with the banner ad to be displayed on client device 510b.

In 880, the user associated with client device 510b may transmit data to be entered on the banner ad within website 580, and complete the transaction associated with vendor server 530 on website 580 that was previously abandoned by the user using client device 510a.

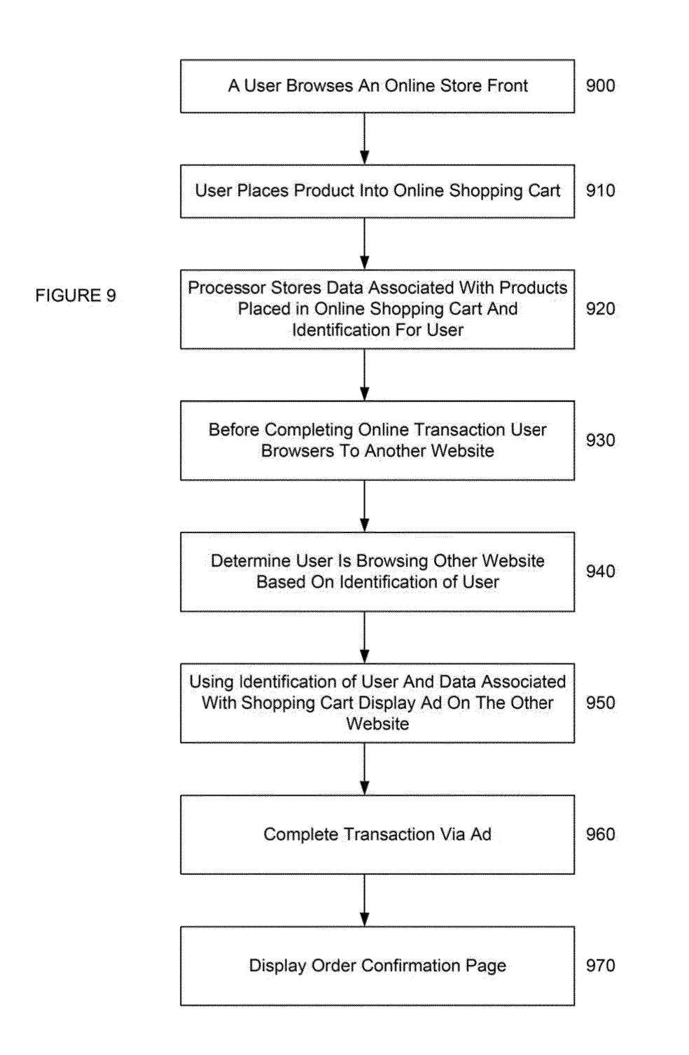

In 890, website 580 may communicate data associated with the completed transaction to vendor server 530. Accordingly, the user associated with client devices 510a-b does not have to navigate to vendor server 530 or transmit any data directly to vendor server 530 to complete the transaction previously abandoned on a different client device 510a. FIG. 9 depicts an example embodiment of a flow diagram utilizing a cross-authorization method for increasing conversion rates across websites and platforms.

At 900, a user on a client device may browse an online store front website associated with a vendor. At 910, the user may put a product into an online shopping cart on the online storefront associated with the vendor.

At 920, while the user on the client device is browsing the online storefront and/or placing products into the online shopping cart, a processor of the online store front may be tracking, recording, storing and/or identifying the actions that the user has taken on the online store front. For example, a processor may store in a database a user ID associated with the user, the products placed within the online shopping cart, and any other user information (i.e., shipping information, payment information and the like). More specifically, the online store front may utilize a tag or html code to track, record, and/or store information associated with the user's activity on the online storefront.

At 930, before completing an online transaction, the user may navigate away from the online store front to another website.

At 940, utilizing an identification of the user, the other website may be able to identify or recognize the user. For example, utilizing the tag or html code the website may identify and/or recognize that the user was previously shopping at the online storefront.

At 950, utilizing the information stored in the database to identify or recognize the user, a banner ad may be displayed on the other website allowing the user to complete the abandoned transaction via the other website. For example, the banner ad may include the product, price of the product, shipping methods and/or payment methods if the user had entered this information on the online storefront before navigating away from online storefront. If the user had not entered the shipping methods and/or payment methods for the product on the online storefront before navigating away to the other website, the banner ad may include a graphical user interface where the user can enter such information. Furthermore, the banner ad may include a purchase button, which if pressed may complete the transaction for the user for the online storefront on the other website via the banner ad.

At 960, the user may complete the previously abandoned transaction directly through the banner ad displayed on the other website

At 970, after completing the online transaction via the banner for the online storefront, the user may be linked or directed to an order confirmation webpage associated with the items purchased from the online storefront.

Accordingly, utilizing the above-mentioned method a user may purchase items from an online storefront on another webpage via an advertisement or link displayed on the other webpage. Therefore, fewer steps are required to complete an online transaction for a transaction that was earlier abandoned.

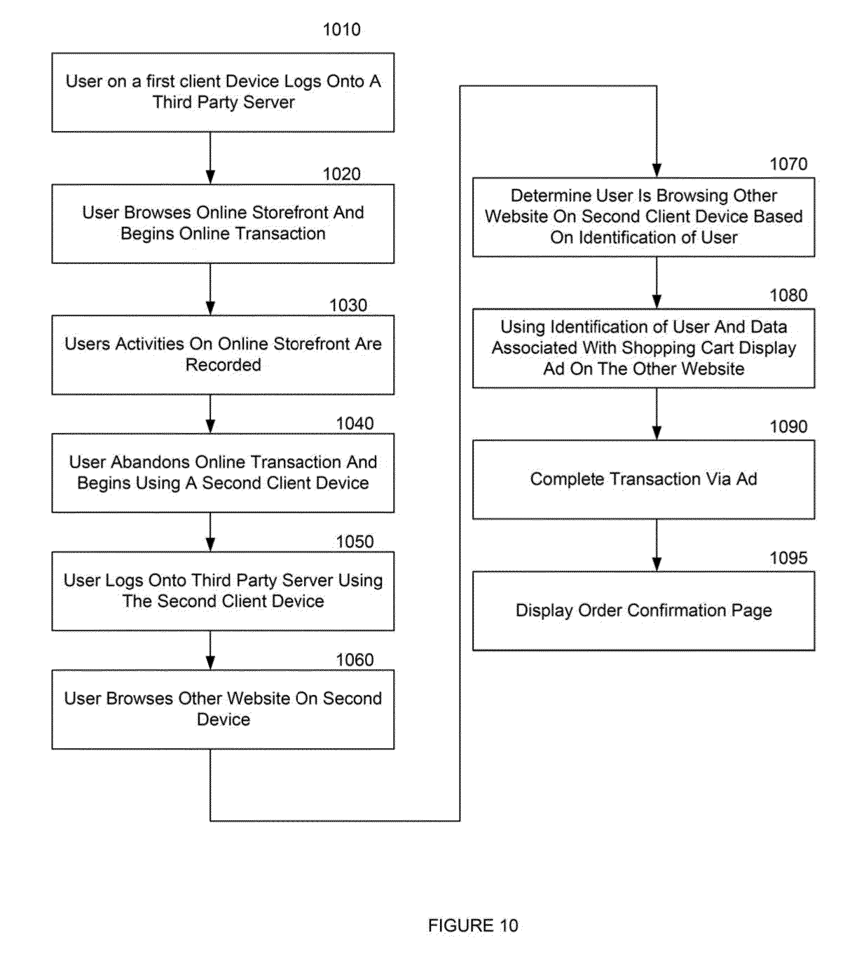

FIG. 10 depicts an example embodiment of a flow diagram utilizing a cross-authorization method for increasing conversion rates across websites and different devices.

At 1010, a user on a first client device may login to a third party server.

At 1020, the user on the first client device may browse a website and begin a transaction on the website.

At 1030, while the user on the first client device is browsing the online storefront and/or placing products into the online shopping cart, a processor may be tracking, recording, storing and/or identifying the actions that the user has taken on the online store front. For example, a processor may store in a database a user ID associated with the user, the products placed within the online shopping cart, and any other user information (e.g., shipping information, payment information and the like). More specifically, the processor may utilize a tag or html code to track, record, and/or store information associated with the user's activity on the online storefront.

At 1040, the user may abandon the transaction on the website, and the user may stop using the first client device and begin using a second client device.

At 1050 the user may login to the third party server on the second client device, and begin browsing another website.

At 1060, utilizing an identification of the user, a server (such as the third party server) may be able to identify or recognize that the user is browsing the other website. For example, utilizing the tag or html code the website may identify and/or recognize that the user was the same user who was previously shopping at the online storefront while using the first client device.

At 1070, utilizing the information stored in the database, a server may identify or recognize the user utilizing the second client device

At 1080, a banner ad may be displayed on the other website allowing the user to complete the abandoned transaction on the first client device via the other website. For example, the banner ad may include the product, price of the product, shipping methods and/or payment methods if the user had entered this information on the online storefront. If the user had not entered the shipping methods and/or payment methods for the product on the online storefront, the banner ad may include a graphical user interface where the user can enter such information.

At 1090, the user may be complete the transaction on the banner ad displayed on the other website on the second client device. For example, the banner ad may include a purchase button, which if pressed may complete the transaction for the user with the online storefront on the other website via the banner ad. Therefore, the user may complete transactions on a second client device without having to visit the online storefront with the second client device.

At 1095, after completing the online transaction via the banner for the online storefront, the user on the second client device may be linked or directed to an order confirmation webpage associated with the items purchased for the online storefront.

Accordingly, utilizing the above-mentioned a user may purchase items from an online storefront on a second device via an advertisement or link displayed a second client device. Therefore, fewer steps are required to complete an online transaction for a transaction that was earlier abandoned.

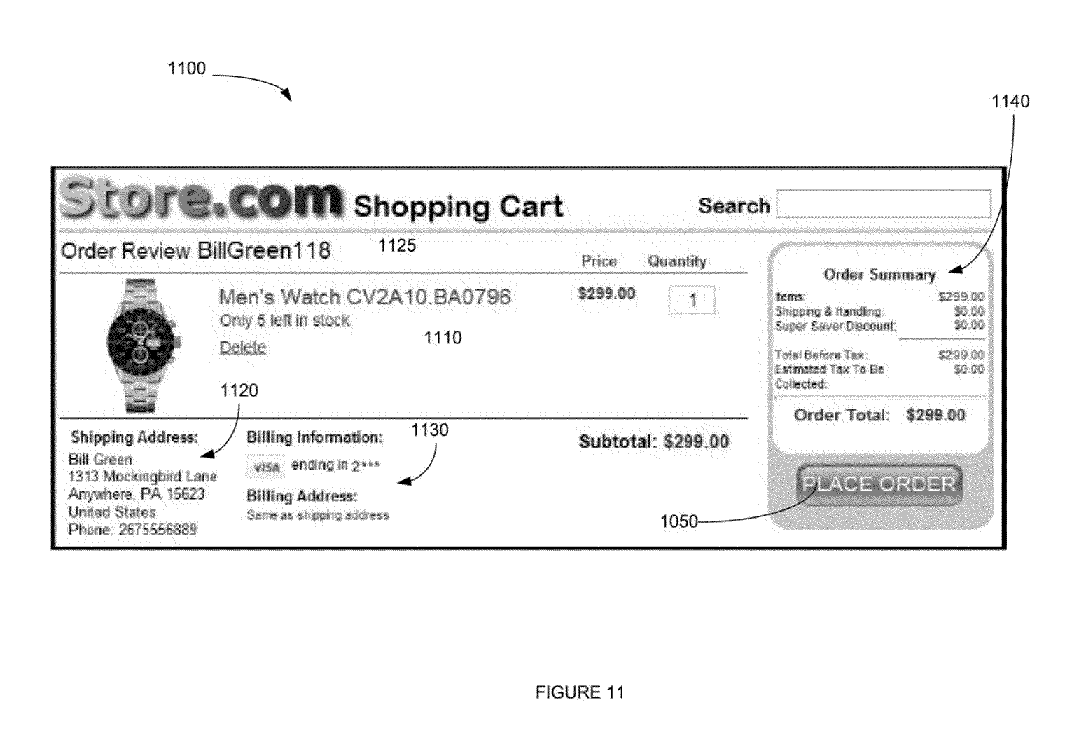

FIGS. 11-13 depict graphical user interfaces that may be displayed on a screen of a user device to complete a transaction. More specifically, FIG. 11 depicts a checkout screen 1100 for a website of an online vendor. Checkout screen 1100 may include product information 1110, user login 1125, shipping information 1120, billing information 1130, order summary information 1140, and a checkout button 1150.

Product information 1110 may include information regarding a product that was placed in an online shopping cart of an online vendor. More specifically, product information 1110 may include an identification of a product (such as a product name), price of the product and quantity of the product.

User login 1125 may be a login name associated with a corresponding user desiring to purchase a product via checkout screen 1100. Shipping information 1120 may include information regarding where a product should be shipped. More specifically, shipping information 1120 may include a name of the user, address of the user, and/or a phone number for the user. Billing information 1130 may include a method of payment the user intends to use to purchase the product. For example, billing information 1130 may include a type of credit card and an associated credit card number, any other method of payment, and a billing address associated with the user. In further example embodiments, a user's preferences for billing information 1130 and/or shipping information 1120 may be pre-entered and attached to a user via user identification.

For example, at a login screen for an online vendor, a user may create a user account including a user identification name 1125, a password, shipping information 1120, and/or billing information 1130. Therefore, for subsequent purchases for a vendor, the user may login to an account on the website for the user, and the corresponding shipping address 1120 and/or billing information 1130 may be preset.

Order summary information 1140 may include a summary of an order to be placed. For example, order summary information may include a price of the product, discounts offered, shipping and handling costs, and/or taxes.

Checkout button 1150 may be a button configured to be clicked or pressed by a user to complete a transaction associated with checkout screen 1100. Upon a user selecting checkout button 1150, a user may be directed to an order confirmation page.

In various example embodiments, a user may have completed fields within billing information 1130 and/or shipping information 1120. In other example embodiments, a user may have not completed fields within billing information 1130 and/or shipping information 1120. For example, in an embodiment a user may have not included a shipping address and/or billing information for a product. However, as discussed later, if browsing away from checkout screen 1100, a user may enter this information at another website via a banner ad.

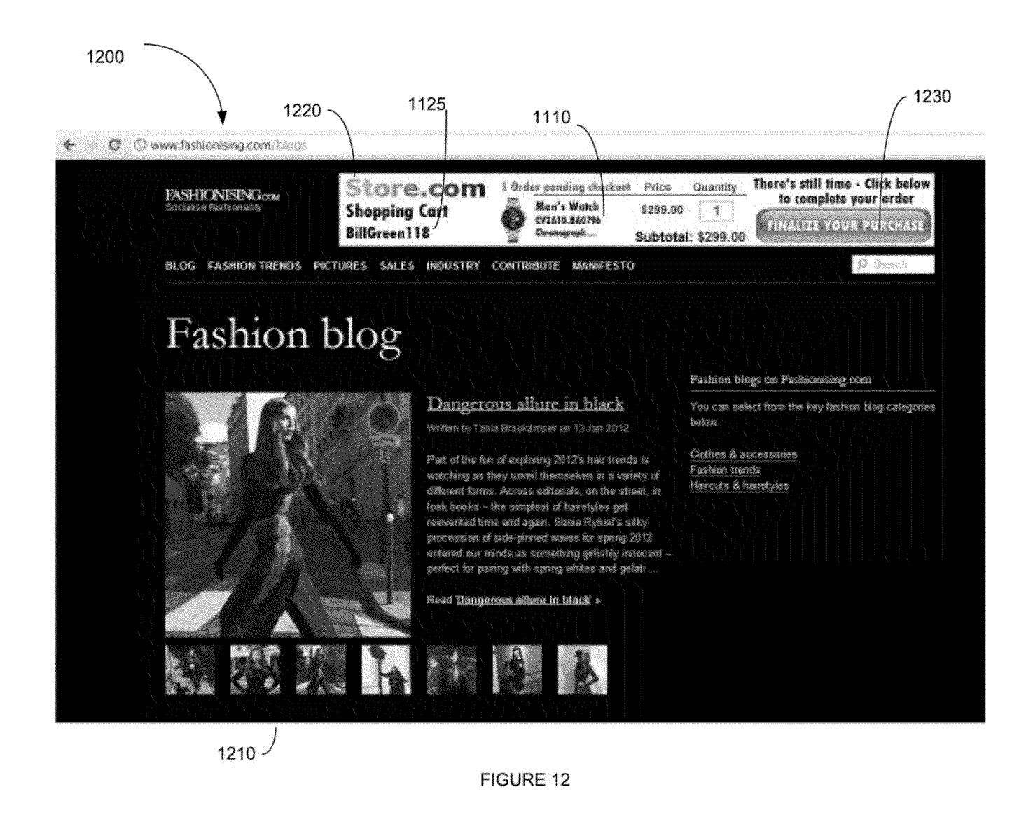

FIG. 12 depicts a webpage 1200 for another website that may be displayed on a graphical user interface of a client device if a user navigates away from checkout screen 1100 to another website or changes user devices and starts navigating the internet before pressing checkout button 1150 to complete a transaction. Webpage 1200 may include information 1210 associated with the other webpage and a banner ad 1220. Banner ad 1220 may be associated with the web vendor corresponding to checkout page 1100, as shown in FIG. 11.

Banner ad 1220 may include a user identification 1125, product information 1110 and a finalize checkout button 1230. Furthermore, if a user had logged onto an account for an online vendor associated with checkout screen 1100, banner ad 1220 may not include the shipping information and/or billing information for the user because these preferences may already be set. However, if the user had not created an online account for an online vendor associated with checkout screen 1100, banner ad 1220 may further include text boxes where the user could create free form text to enter the user shipping and/or billing information. In further example embodiments, banner ad 1220 may not include fields such as shipping information and/or billing information unless the banner ad 1120 is clicked or selected or an icon is rolled over the banner ad 1220. For example, banner ad 1220 may originally not include shipping and/or billing information, but if a user selected banner ad 1220 then the ad may include additional fields such as shipping and/or billing information that may be entered by the user.

If a user selects the checkout button 1230 within banner ad 1220, the user may finalize the previously abandoned transaction associated with checkout screen 1100 via banner ad 1220 on website 1100. In other words, banner ad 1220 allows a user to complete a previously abandoned transaction directly through banner ad 1220 on website 1200.

In further example embodiments, banner ad 1220 may include an incentive, discount and/or coupon for the user to select checkout button 1250 within banner ad 1220. For example, banner ad 1220 may include a five percent discount or a special gift if the user selects the checkout button 1250 before navigating to another web page or within a certain period of time. In another example embodiment, banner ad 1220 may be transformed into a clickable phone number that may allow the customer to complete an order over a telephone.

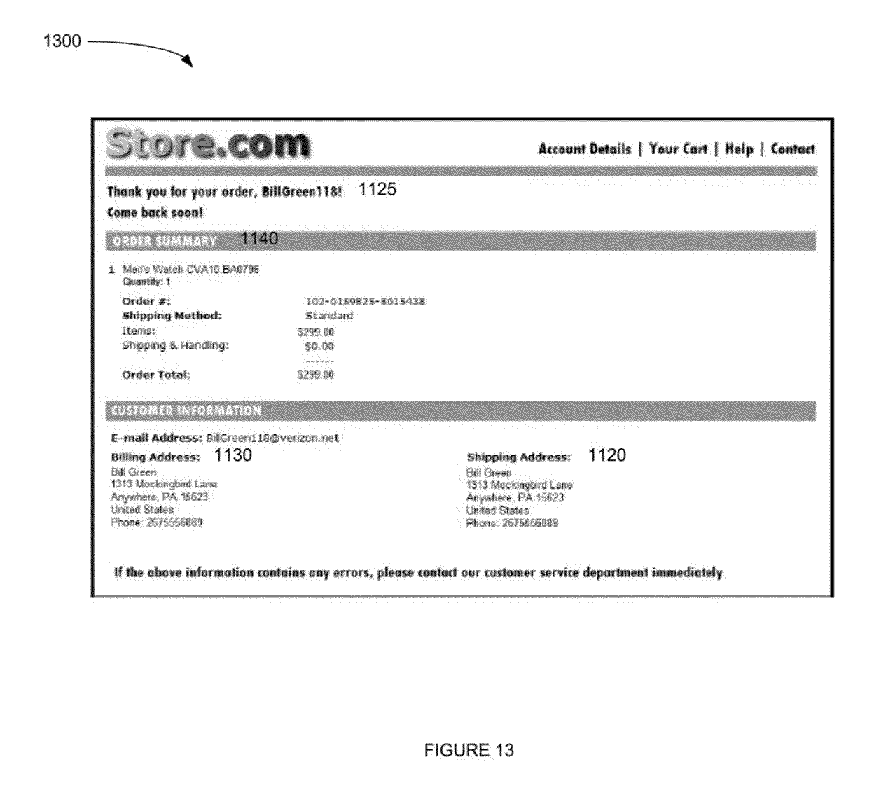

FIG. 13 depicts an order confirmation page 1300. Order confirmation page 1300 may be displayed after a user completes a transaction by clicking or selecting checkout button 1230 within a banner ad 1220 to complete a transaction. Furthermore, order confirmation page 1300 may have user login identification 1125, order summary information 1140, billing information 1130 and/or shipping information 1120.

Order confirmation page 1300 may be used as confirmation for an order such that if any of the user login identification 1125, order summary information 1140, billing information 1130 and/or shipping information 1120 is incorrect, a user may notify the corresponding online vendor.

Although the embodiments as discussed above relate to a user completing previously abandoned transactions for goods and/or services, one skilled in the art will realize that the embodiments may be used to complete any previously abandoned transaction. For example, if a user is registering an account with a website, and the user navigates away from the website before completing the registration of the account. A banner ad may be displayed allowing the user to complete the registration of the user account directly through the banner ad. Furthermore, the website that the user may register a user account with may or may not sell products. For example, a user may complete an abandoned user account registration for a website for news, sports, blogs, or any other website directly via a banner ad displayed on another website. Therefore, the user may not be required to return to the original website to complete the previously abandoned transaction.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments. While the embodiments may be illustrated by using a particular embodiment, this is not and does not limit the invention to any particular embodiment and a person of ordinary skill in the art will recognize that additional embodiments are readily understandable and are a part of the example embodiments.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A system for completing transactions, the system including:
a first processor configured to receive data associated with a user, the data corresponding to at least one action performed by the user associated with a first webpage and an identification of the user, the first processor being further configured to determine if the user has browsed to a second webpage before completing the at least one action associated with the first webpage;
a second processor configured to communicate data to be displayed on an advertisement on the second webpage, the data being associated with the at least one action associated with the first webpage and the identification of the user; and
an interface configured to receive data via the advertisement to complete the at least one action associated with the first website.

2. The system of claim 1, wherein the at least one action corresponds with an online transaction.

3. The system of claim 1, wherein the first website is associated with an online vendor.

4. The system of claim 1, further comprising:
a database configured to store the at least one and the identification of the user.

5. The system of claim 1, wherein the first processor is further configured to receive a request for the advertisement from the second webpage, wherein the request includes an indicator corresponding to the identification of the user.

6. The system of claim 5, wherein the determining that the user has browsed the second webpage is based on comparing the indicator and the identification of the user.

7. The system of claim 1, wherein the advertisement is a banner advertisement, wherein the banner advertisement includes at least one of forms that are configured to receive data from the user and a button to complete the at least one action.

8. The system of claim 1, wherein the at least one action is completed via the advertisement without the user interacting with the first webpage again.

9. A system for completing transactions, the system including:
a first processor configured to receive data associated with a user on a first device, the data corresponding to at least one action performed by the user on the first device associated with a first webpage and an identification of the user, the first processor being further configured to determine if the user has browsed to a second webpage on a second device before completing the at least one action associated with the first webpage;
a second processor configured to communicate data to be displayed on an advertisement on the second webpage on a graphical user interface on the second device, the data being associated with the at least one action performed by the user on the first device on the first webpage and the identification of the user; and
an interface configured to receive data from the second device via the advertisement to complete the at least one action associated with the first website.

10. The system of claim 9, wherein the at least one action corresponds with an online transaction.

11. The system of claim 9, wherein the first website is associated with an online vendor.

12. The system of claim 9, further comprising:
a database configured to store the at least one and the identification of the user.

13. The system of claim 9, wherein the second processor is further configured to receive a request for the advertisement from the second webpage, wherein the request includes an indicator corresponding to the identification of the user.

14. The system of claim 13, wherein the determining that the user has browsed the second webpage on the second device is based on comparing the indicator and the identification of the user.

15. The system of claim 9, wherein the advertisement is a banner advertisement, wherein the banner advertisement includes at least one of forms that are configured to receive data from the user and a button to complete the at least one action.

16. The system of claim 9, wherein the at least one action is completed via the advertisement displayed on the graphical user interface of the second device without the user interacting with the first webpage again.

17. A non-transitory computer readable medium storing a program causing a computer to execute a process, the process comprising:
receiving data associated with a user, the data corresponding to at least one action performed by the user associated with a first webpage and an identification of the user, the first processor being further configured to determine if the user has browsed to a second webpage before completing the at least one action associated with the first webpage;
communicating data to be displayed on an advertisement on the second webpage, the data being associated with the at least one action associated with the first webpage and the identification of the user; and
receiving data via the advertisement to complete the at least one action associated with the first website.

18. The non-transitory computer readable medium of claim 17, wherein the at least one action corresponds with an online transaction.

19. The non-transitory computer readable medium of claim 17, wherein the first website is associated with an online vendor.

20. The non-transitory computer readable medium of claim 17, wherein the process further comprises:
storing the at least one and the identification of the user.
